(19) United States
(12) Patent Application Publication
(10) Pub. No.: US 2007/0107394 A1
(43) Pub. Date: May 17, 2007

(54) Exhaust treatment devices and methods for substrate retention

(76) Inventor: Paul E. Jankowski, Goodrich, MI (US)

Correspondence Address: Paul L. Marshall;Delphi Technologies, Inc., M/C 480-410-202, P.O. Box 5052, Troy, MI, 48007, US

(21) Appl. No.: 11/282,234

(22) Filed: Nov. 17, 2005

(51) Int. Cl. B01D 39/20

(52) U.S. Cl. 55/523

(57) ABSTRACT

Disclosed herein are exhaust treatment devices and methods of manufacturing the same. In one embodiment, an exhaust treatment device can comprise: a substrate, a ring disposed about the substrate, and a retention material disposed between the ring and a formed shell. The formed shell can compress the retention material and restrict motion of the ring. The ring can have a portion extending from adjacent the substrate to adjacent the formed shell. In one embodiment, the method for manufacturing an exhaust treatment device can comprise: assembling a ring on a substrate, disposing a retention material in contact with the ring, on a side of the ring opposite the substrate, to form a substrate assembly, and disposing the substrate assembly within a formed shell.

### TECHNICAL FIELD

This disclosure generally relates to exhaust treatment devices and methods for manufacturing the same.

### BACKGROUND

Exhaust treatment devices have demonstrated to be effective at remediating undesirable gaseous emissions (e.g., nitrogen oxides (e.g., nitric oxide, nitrogen dioxide), carbon monoxide, hydrocarbons, and the like) and solid carbonaceous particulate matter from exhaust streams. These devices are capable of providing these functions in part due to innovations in substrates, which can be configured to provide various functions. Substrates employed for remediating gaseous emissions can support catalysts capable of converting components of the exhaust stream into less undesirable compounds. Substrates utilized for the reduction of particulate matter can comprise a porous media capable of trapping and oxidizing particulate matter at elevated temperatures (about 600° to about 1,600° Celsius).

Substrates can be retained within a shell using retention material (also referred to as “mat” or “matting”), which can be concentrically disposed between the device's shell and the substrate to exert retention forces on the substrate. The amount of retention force applied to the substrate can affect performance. Too low of a retention force can allow the substrate to shift and possibly incur damage, and too high of a retention force can cause cracks in the substrate which can lead to decreased efficiency. This is especially relevant in particulate filters, which can generate higher exhaust pressure gradients across their filter substrate than those normally encountered in devices that employ catalytic substrates. These pressure gradients result in higher axial forces acting on the filter substrate that can require higher retention forces to ensure proper retention of the substrate.

In addition to offering substrate retention, matting also offers the benefit of impact resistance. This is desirable as substrates can be produced with wall thicknesses of less than 0.005 inches (0.127 millimeters (mm)), and in some cases even less than 0.003 inches (0.076 mm). In designs that employ these wall thicknesses the substrate can be brittle and susceptible to cracking upon impact. Matting, however, is capable of protecting the substrate from occasional impacts encountered by the device's shell during use, such as, impacts from debris, mounting failures, accidents, and the like.

The matting, however, can degrade over time. When degradation of the mat occurs, the fibrous structure can break down and form fibrous particulate that can migrate into the exhaust stream. When the fibrous particulate migrates into the upstream end of the device, the fibrous particulate can enter the particulate filter and become trapped. As the fibrous particulate does not degrade at the device's normal operating temperatures, the substrate can become plugged, reducing efficiency and increasing restriction to exhaust flow. Furthermore, fibrous particulate can also migrate downstream of the filter substrate and cause similar effects to additional exhaust treatment devices.

Therefore, although matting can provide the benefits of substrate retention and impact resistance, disadvantages such as potential substrate cracking due to excessive retention forces and fibrous particulate migration can occur. To curtail the occurrence of these drawbacks, device manufacturers desire innovations in substrate retention designs and methods that can provide adequate retention forces without fibrous particulate migration.

### BRIEF SUMMARY

Disclosed herein are exhaust treatment devices and methods of manufacturing the same. In one embodiment, an exhaust treatment device can comprise: a substrate, a ring disposed about the substrate, and a retention material disposed between the ring and a formed shell. The formed shell can compress the retention material and restrict motion of the ring.

In one embodiment, the method of manufacturing an exhaust treatment device can comprise: assembling a ring on a substrate, disposing a retention material in contact with the ring, on a side of the ring opposite the substrate, to form a substrate assembly, and disposing the substrate assembly within a formed shell.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a cross-sectional view of an exemplary exhaust treatment device.

FIG. 2 is a cross-sectional view of an exemplary device sub-assembly.

FIG. 3 is a cross-sectional and partial view of an exemplary alternative device sub-assembly.

FIG. 4 is a side view of an exemplary modified substrate assembly.

### DETAILED DESCRIPTION

Disclosed herein are exhaust treatment devices and methods of manufacturing the same that provide substrate retention, enhanced assembly options, and reduce or eliminate matting fiber migration, particulate migration, and so forth.

The terms “upstream” and “downstream” will be disclosed herein, and are to be interpreted with respect to the general direction of an exhaust stream flowing from an upstream position to a downstream position. Furthermore, ranges disclosed herein are inclusive and independently combinable (e.g., ranges of “up to about 25 wt %, or, more specifically, about 5 wt % to about 20 wt %”, are inclusive of the endpoints and all intermediate values of the ranges of “about 5 wt % to about 25 wt %,” etc). The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). Also, the terms “front”, “back”, “bottom”, and/or “top” are used herein, unless otherwise noted, merely for convenience of description, and are not limited to any one position or spatial orientation. The suffix “(s)” as used herein is intended to include both the singular and the plural of the term that it modifies, thereby including one or more of that term (e.g., the metal(s) includes one or more metals).

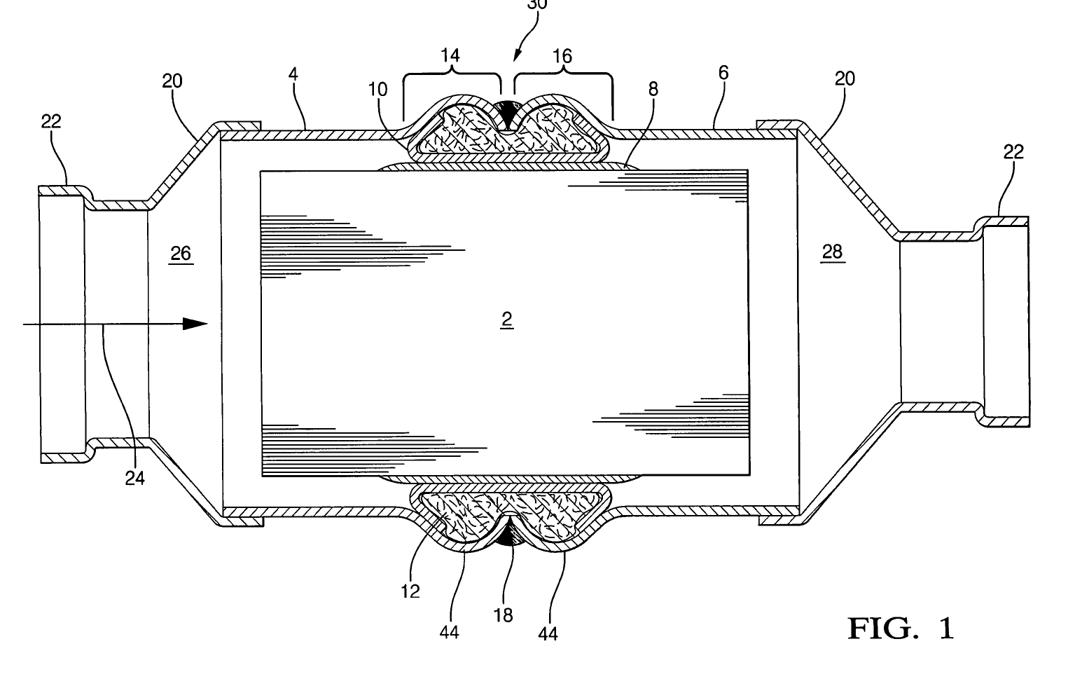

Referring now to FIG. 1, a cross-sectional view of an exemplary exhaust treatment device, generally designated 30, is illustrated. Exhaust treatment device 30 comprises a substrate 2, which is capable of treating an exhaust stream 24. The exhaust stream 24 flows through the substrate from an upstream end 26 to a downstream end 28. A ring 10 is attached to the substrate 2 by bond 8. Disposed within the ring 10 can be retention material 12. The ring 10 and the retention material 12 can be compressed within a formed shell 44, which comprises an upstream shell 4 and a downstream shell 6. The upstream shell 4 comprises an upstream formed section 14 and the downstream shell 6 comprises a downstream formed section 16. The upstream shell 4 and the downstream shell 6 can be connected at the formed section 14 and the formed section 16 with, for example, a weld 18. Upstream shell 4 and downstream shell 6 can be connected to end-cones 20 that can comprise snorkels 22 configured to connect to an exhaust conduit (not shown).

Compressing the ring 10 within the formed shell 44 inhibits, and desirably prevents, movement of the substrate 2 (which can be attached to the ring 10), creates a barrier between the ring 10 and the formed shell 44 that minimizes or prevents migration of fibrous particulate from the retention material 12 into the exhaust stream 24, and forms a barrier between the retention material 12 and shell 44. The barrier between the retention material 12 and shell 44 minimizes or prevents the exhaust stream 24 from flowing around substrate 2 and through the interface of the retention material 12 and the formed shell 44.

It is to be noted that the ring 10 can endure the compression forces of the formed shell 44, which could otherwise cause cracking of the substrate 2 if the ring 10 was not employed. In addition, because the ring 10 can withstand greater compression forces than designs that do not employ a ring 10, if desired, the device illustrated in FIG. 1 can be configured with retention material 12 that is compressed to a greater extent than designs that do not employ a ring 10, to provide greater resistance to the flow of the exhaust stream 24 around the substrate and through the formed shell 44 section.

The substrate 2 can comprise many configurations, such as, but not limited to, foils, preforms, monolith, fibrous materials, porous materials (e.g., sponges, foams, molecular sieves, and so forth), pellets, particles, and the like. For example, the substrate 2 may comprise a gas permeable ceramic monolith with a plurality of parallel channels, wherein the substrate 2 is divided into inlet channels and exit channels (e.g., alternating inlet and outlet channels). In this design, the inlet channel is open at the upstream end of the substrate 2 and plugged at the exit end. Conversely, the outlet channels are disposed open to the downstream end of the substrate 2 and plugged at the inlet end. The inlet channels and outlet channels can be separated by porous walls, which are capable of allowing passage of exhaust gases from the inlet channels, through the walls, into the outlet channels, while trapping particulate. The geometry of the substrate 2 can be of any configuration, such as, but not limited to, a cylindrical geometry comprising a circular, oval, polygonal, or other cross-section taken in a direction perpendicular to the exhaust flow direction.

Any materials capable of withstanding the elevated operating temperatures of device can be employed for the substrate 2. The substrate 2 can operate at about 300° C. (degree Celsius) in underfloor applications to about 1,600° C. in manifold mounted or close-coupled applications. Different temperature ranges are experienced in different types of exhaust systems (e.g., a diesel exhaust versus a gasoline exhaust). Materials such as, but not limited to, cordierite, silicon carbides, metal oxides, metals, metallic alloys, and the like, as well as combinations comprising at least one of the foregoing, can be successfully employed. Furthermore, substrate 2 can be manufactured by any method commonly employed for forming such substrates, such as extrusion, molding, metal forming, sintering, and so forth.

Substrates 2 can also comprise catalytic material(s), which can be capable of reducing the concentration of at least one component in the exhaust gas and/or capable of facilitating oxidation (e.g., reducing oxidation temperatures) in the substrate. The catalyst can comprise material(s) such as, barium, cesium, vanadium, molybdenum, niobium, tungsten platinum, palladium, rhodium, iridium, ruthenium, zirconium, yttrium, cerium, lanthanum, and the like, as well as oxides comprising at least one of the foregoing, alloys comprising at least one of the foregoing, as well as combinations comprising at least one of the foregoing, can be employed. The catalysts can be applied to the substrate 2 employing a wash coating, spraying, imbibing, impregnating, physisorbing, chemisorbing, precipitation, and/or other process.

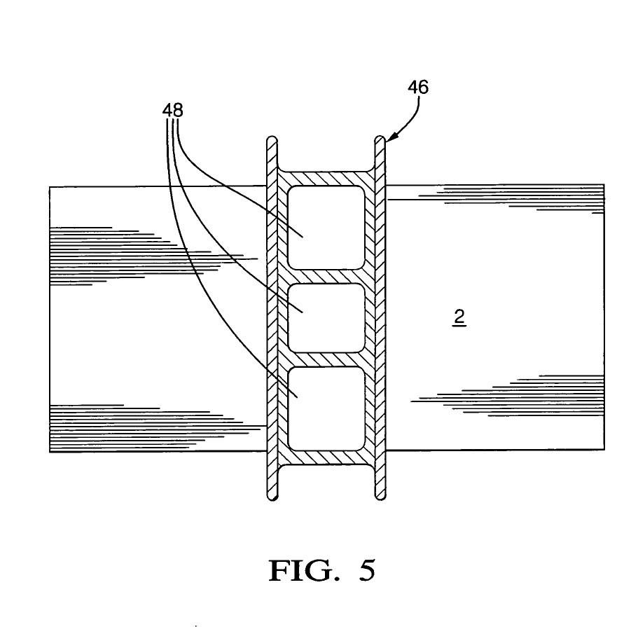

The optional bond 8 can comprise any material capable of retaining the ring 10 in a desired position on the substrate 2. More specifically, the bond 8 can be capable of adhering the ring 10 to the substrate 2 by forming an adhesive bond therebetween (as illustrated in FIGS. 1-3), and/or can be capable of forming interference features that restrict the movement of ring 10 (as illustrated in FIG. 4). It is desirable the bond 8 can withstand the potential operating temperatures of the device. Suitable bonds 8 include cermet materials comprising at least a ceramic component (e.g., oxide, boride, carbide, alumina) and a metallic component (e.g., molybdenum, nickel, cobalt, chromium, titanium, aluminum), metal matrix composites (e.g., tungsten carbide, boron nitride), bonding agents, and so forth, as well as combinations comprising at least one of the foregoing.

The ring 10 can comprise materials (e.g., non-porous materials) such as, but not limited to, metals (e.g., copper, aluminum, iron) and metal alloys (e.g., martensitic, ferritic, and austenitic stainless materials). Stainless steels can be particularly useful since they can provide a malleable ring 10 capable of compressing the retention material 12 as illustrated in FIG. 1, and can provide corrosion resistance and an extended working life. The ring 10 can comprise a single component fabricated from a homogeneous material (as shown), or can comprise multiple components assembled together, and optionally comprising more than one material. For ease of assembly and efficiency, a single component ring is desirable.

The ring 10 can comprise any width that capable of providing ample retention of the substrate 2. The width is a function of the substrate's strength, mass, expected vibration levels, and pressure drop. If the ring's width is inadequate, the substrate 2 can potentially shift and incur damage within the formed shell 44. Alternatively, if the substrate 2 is over constrained, variations in temperature can generate shear forces that can potentially exceed the substrate's strength and cause damage. In addition, although the ring 8 can be configured in any position along the length of the substrate 2, if positioned in about the center of the substrate's ends will be capable of shrink and expand to temperature changes.

Retention material 12 can comprise materials such as, intumescent materials (e.g., a material that comprises vermiculite component, i.e., a component that expands upon the application of heat), non-intumescent materials (e.g., ceramic preforms, ceramic fibers, organic binders, inorganic binders, and the like), as well as combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescent materials which are also sold under the aforementioned “FIBERFRAX” trademark.

The retention material 12 can comprise any configuration that resists exhaust gas leaking from the upstream end 26 to the downstream end 28 through the retention material 12. For example, the retention material 12 can comprise a woven or non-woven material, e.g., a strip of homogeneous material (as shown) that can be disposed within (e.g., wrapped around) the ring 10. If the material is a strip of homogeneous material, desirably, the ends are capable of merging together in an interlocking configuration to prevent exhaust leakage therethrough. In another example, the retention material 12 can comprise a ring that can be disposed within the ring 10 (e.g., stretched over and disposed within the ring 10). The retention material 12 can comprise a multilayer configuration with different layers optionally comprising different basis weights. For example, the retention material 12 can have an internal layer of intumescent material comprising a nominal basis weight of about 1,600 to about 2,000 grams per square meter (g/m²) (e.g., 1,800 g/m²) and an outer layer comprising a material with a nominal basis weight of about 1,000 g/m² to about 1,400 g/m² (e.g., 1,200 g/m²). It is also to be apparent that the retention material 12 is not limited to the above examples. Alternative matting configurations are also possible, such as pellets, fibers, and the like.

The housing components comprise upstream shell 4, downstream shell 6, as well as optional: end-cone(s) 20, end-plate(s) (not shown), and snorkel(s) 22. The housing components can be fabricated of any materials capable of withstanding the temperatures, corrosion, and wear encountered during the operation of the exhaust treatment device 30 and capable of retaining compressive forces about the retention material 12 for the duration of the devices service life. Applicable materials include, but are not limited to, metals (e.g., copper, aluminum, iron), metal alloys (e.g., martensitic, ferritic, and austenitic stainless materials), and the like. Furthermore, the housing components can be produced utilizing any common forming methods, such as, but not limited to, stamping, crimping, spin-forming, profiling, and necking, and can comprise one or multiple components. Also, the shape of the housing components can be of any design, such as, but not limited to cylindrical with circular or non-circular cross-sectional geometries (e.g., oval, polygonal), taken in a direction perpendicular to the flow of the exhaust gas. Furthermore, the upstream shell 4 and the downstream shell 6 can be integrally formed with an end-cone 20 and a snorkel 22 if desired.

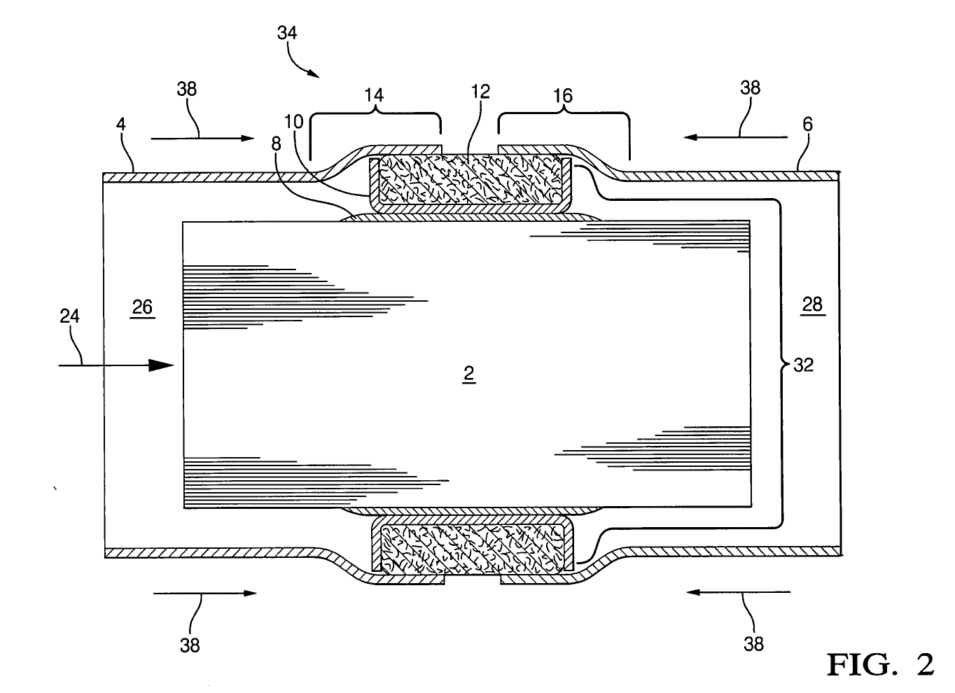

Referring now to FIG. 2, a cross-sectional view of an exemplary device sub-assembly, generally designated 34, is illustrated. In the illustration, the device sub-assembly 34 is depicted during one exemplary manufacturing process. The process comprises securing ring 10 about substrate 2 via bond 8. The ring 10 can be secured to the substrate 2 in any position, however a position disposed approximately in the middle of the substrate 2 can reduce potential occurrences of incorrect assembly, and can provide substantially uniform retention force to the substrate.

Once secured, retention material 12 can be disposed in ring 10 to form a substrate assembly 32 comprising: substrate 2, bond 8, ring 10, and retention material 12. After the substrate assembly 32 has been assembled, it can be disposed within the upstream shell 4 and the downstream shell 6. Thereafter, the upstream shell 4 and the downstream shell 6 can be compressed together (as illustrated by compression forces 38) to produce upstream formed section 14 and the downstream formed section 16, thereby compressing ring 10 onto retention material 12. Optionally, the upstream shell 4 and the downstream shell 6 can be brought together and crimped. In some embodiments, one of the shells can be slightly larger than the other such that, when they are brought together, the end of the smaller shell fits within the end of the larger shell. The fit can be a pressure fit or a slip fit, and the overlapping portion can then, optionally, be crimped.

The force exerted on the ring 10 can cause the ring 10 to deform, as seen when comparing FIG. 1 and FIG. 2. This deformation can secure the substrate assembly 32 between the upstream shell 4 and the downstream shell 6, thereby preventing translation. In a simultaneous or subsequent action, the upstream formed section 14 and the downstream formed section 16 can be formed utilizing a metal forming process, such as, but not limited to, stamping, crimping, spin-forming, profiling, and/or necking. Optionally, the shells can be further secured together with any appropriate method, such as employing a weld 18 (as illustrated in FIG. 1). This process causes the upstream formed section 14 and the downstream formed section 16 to contact and compress the retention material 12 and the ring 10. This compression forms a seal between the substrate assembly 32 and the shell halves (upstream shell 4 and downstream shell 6) capable of preventing the exhaust stream 24 from flowing around the substrate 2 from the upstream end 26 to the downstream end 28. The compression also forms a seal between the ring 10 and the shell halves that can minimize or prevent migration of fibrous particulate from the retention material 12 into the exhaust stream 24.

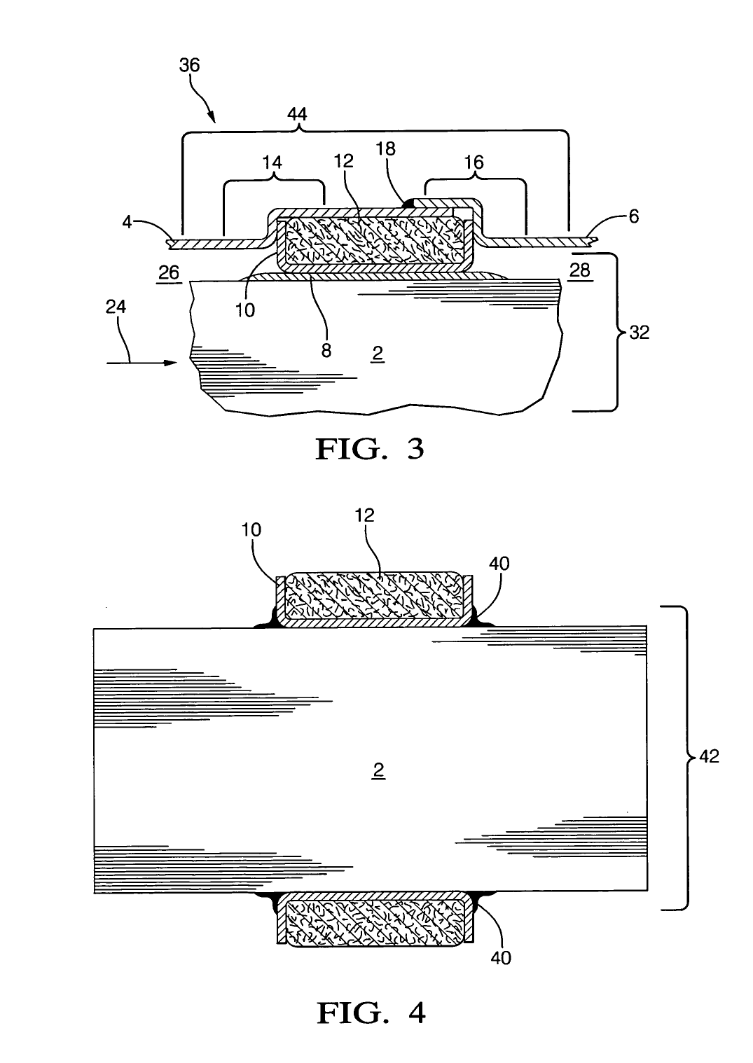

Referring now to FIG. 3, a cross-sectional and partial view of an exemplary modified device sub-assembly, generally designated 36, is illustrated. In the illustration, the modified device sub-assembly 36 is shown assembled. The assembly can be constructed by first securing the ring 10 to the substrate 2 using a bond 8. As discussed prior, the ring 10 can be disposed at any position along the substrate 2, such as in a position located at about the center of the substrate 2. Thereafter retention material 12 can be disposed in ring 10, forming a substrate assembly 32. The retention material 12 can then be compressed and the substrate assembly 32 can be introduced into an upstream shell 4. A downstream shell 6 can they be assembled onto the upstream shell 4 and ring 10 can be compressed therebetween. The shell halves can then be secured together using a weld 18.

In this configuration the retention material 12 can comprise an intumescent material that can exert ample force on the upstream shell 4 to form a barrier in which the exhaust stream 24 cannot pass through. Furthermore, although ring 10 is not deformed similar to the amount of deformation shown in FIG. 1, the upstream shell 4 and the downstream shell 6 can provide ample compression on the ring 10 to form a barrier through which fibrous particulate from the retention material 12 cannot pass.

It is to be apparent that the components in the exemplary devices disclosed herein can be modified to encourage sealing. For example, the properties (e.g., density) and configuration (e.g., thickness, width, cross-sectional geometry) of the retention material 12 can be configured to provide the desired barrier. Likewise, the ring 10 can comprise a taper, flare or lip to encourage sealing with the shell halves. Additionally, a material can be disposed between the ring and the shell to further enhance the barrier properties.

Referring now to FIG. 4, a side-view of an exemplary modified substrate assembly 42 is illustrated. In the illustration, an alternative assembly method is disclosed wherein ring 10 can be secured to the substrate utilizing a fillet 40 of bond 8. The modified substrate assembly 42 can be assembled by first disposing the ring 10 on the substrate 2. Thereafter, bond 8 can be disposed around the substrate 2 to form a fillet 40 of bond 8, thereby restricting the motion of the ring 10. Retention material 12 can then be disposed in the ring 10, and the device can be further assembled utilizing any method.

Referring now to FIG. 5, a side view of an exemplary modified ring 46 is illustrated. In the illustration, the modified ring 46 is assembled onto a substrate 2. The modified ring 46 can be utilized in a manner similar to that illustrated in FIGS. 1-4, however without bond 8 or a fillet 40 to retain the substrate 2 therein. In this embodiment, the substrate 2 is retained by the compressive force of the retention material 12 through cut-outs 48 in the modified ring 46. It is envisioned that the substrate 2 utilized in conjunction with this embodiment comprise sufficient strength, and can be fabricated of any material, such as metal(s). The modified ring 46 can be sized to mate with the substrate 2 without an excessive gap therebetween. Furthermore, the cut-outs 48 can be configured in any shape, orientation, or configuration which is desired.

The configurations illustrated in FIGS. 1-4 can employ the “stuffing” method of assembly, wherein a stuffing cone (not shown) can be employed to insert the substrate assembly 32 into the upstream shell 4 and/or the downstream shell 6. To be more specific, a stuffing cone serves as an assembly tool, which can attach to one end of the shell. The attached end can comprise an inside cross-sectional geometry similar to that of the inside of the shell, and the cone can gradually increase in diameter from the shell along the stuffing cone's length. This provides a taper that is capable of compressing the retention material on the substrate assembly 32 as it is advanced through the cone and into the upstream formed section 14 or the downstream formed section 16.

An alternative method of assembly can employ the “clamshell” assembly method. In the clamshell assembly method, the substrate assembly 32 can be encapsulated within two mating housing halves that can comprise the features of a formed shell 44. The halves can be connected to one another to form an assembled device, utilizing methods such as welding, crimping, and the like.

It is also envisioned the “tourniquet” assembly method can be employed. In the tourniquet method of assembly, a substrate assembly 32 can be wrapped with a steel sheet, which can comprise the features of a formed shell 44. The sheet can then be fastened at a seam utilizing methods such as welding, crimping, and the like.

The above described exhaust treatment devices that provide several benefits. For example, the integration of the ring 10 hinders migration of retention material 12 fibers, thereby reducing the possibility of fibrous particulate accumulating within the device and in downstream devices. Additionally, the ring 10 can endure high compression forces that can be exerted by the retention material 12, thereby enabling device manufacturers to increase retention material 12 compression while reducing and/or eliminating occurrences of substrate 2 cracking. Furthermore, the devices offer increased assembly options for manufacturers and offer a potential cost savings by employing less retention material 12 than designs that do not employ the ring. Combined, these benefits can result in expanded assembly options and lower assembly cost for manufacturers, and provide consumers with a higher quality product.

The ring employed in the exhaust treatment device can, once the exhaust treatment device has been assembled, have an upstream portion that extends to block the space between the substrate and the shell, and optionally a downstream portion that similarly extends to block the space between the substrate and the shell. Since the retention material is disposed in a downstream side of the upstream portion, fibers (as well as particles and the like) from the retention material, is prevented from entering the upstream end of the substrate. It is also noted that the ring can have a length that is less than or equal to the length of the substrate, with a ring having a length (e.g., from an upstream end to a downstream end, based upon a flow direction), of less than or equal to about 75% of a substrate length, or, more specifically, less than or equal to about 50% of the substrate length, or, even more specifically, less than or equal to about 35% of the substrate length, and yet more specifically, less than or equal to about 25% of the substrate length. As a result, the amount of retention material employed can be reduced.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust treatment device, comprising:
a substrate;
a ring disposed about the substrate; and
a retention material disposed between the ring and a formed shell, wherein the formed shell compresses the retention material and restricts motion of the ring;
wherein the ring has a portion extending from adjacent the substrate to adjacent the formed shell.

2. The exhaust treatment device of claim 1, wherein a barrier is formed between an upstream end and a downstream end.

3. The exhaust treatment device of claim 1, further comprising a bond disposed in contact with the substrate and the ring.

4. The exhaust treatment device of claim 1, wherein the formed shell comprises an upstream shell and a downstream shell.

5. The exhaust treatment device of claim 4, wherein an upstream formed section of the upstream shell fits within a downstream formed section of the downstream shell.

6. The exhaust treatment device of claim 5, wherein the upstream formed section fits within the downstream formed section.

7. The exhaust treatment device of claim 4, wherein an upstream formed section of the upstream shell and a downstream formed section of the downstream shell compress the retention material.

8. The exhaust treatment device of claim 4, wherein the upstream formed section connects to the downstream formed section with a weld.

9. The exhaust treatment device of claim 1, wherein the ring comprises metal or metal alloy.

10. An exhaust treatment device of claim 1, wherein the ring comprises a cut-out portion, and wherein the retention material is disposed in the cut-out portion.

11. An exhaust treatment device of claim 1, wherein the ring has a ring length of less than or equal to about 50% of a substrate length.

12. An exhaust treatment device of claim 11, wherein the ring length is less than or equal to about 35% of the substrate length.

13. A method for manufacturing an exhaust treatment device, comprising:
assembling a ring on a substrate;
disposing a retention material in contact with the ring, on a side of the ring opposite the substrate, to form a substrate assembly; and
disposing the substrate assembly within a formed shell.

14. The method of claim 13, wherein assembling the ring on the substrate further comprises disposing a bond in contact with the substrate and the ring.

15. The method of claim 13, further comprising compressing the retention material with at least a portion of the formed shell.

16. The method of claim 13, further comprising compressing the ring with at least a portion of the formed shell.

17. The method of claim 13, wherein the disposing of the substrate assembly within the formed shell further comprises disposing an upstream shell fits and a downstream shell over the substrate assembly, and compressing the retention material with an upstream formed section of the upstream shell and a downstream formed section of the downstream shell.

18. The method of claim 13, wherein the ring comprises a cut-out portion, and wherein the retention material is disposed in the cut-out portion.
